(19) United States
(12) Patent Application Publication
(10) Pub. No.: US 2017/0272902 A1
(43) Pub. Date: Sep. 21, 2017

(54) HANDLING SENSOR INFORMATION

(71) Applicant: Nokia Technologies Oy, Espoo (FI)

(72) Inventors: Ilia Safonov, Moscow (RU); Mikhail Pikhletsky, Moscow (RU); Ilya Gartseev, Moscow (RU); Marc Bailey, Cambridge (GB)

(21) Appl. No.: 15/504,999

(22) PCT Filed: Jul. 28, 2015
(86) PCT No.: PCT/FI2015/050512

§ 371 Date: Feb. 17, 2017

(30) Foreign Application Priority Data
Aug. 22, 2014 (RU) 2014134331

(51) Int. Cl. H04W 4/02; G01P 15/18; G06N 5/02; G01P 21/00

(52) U.S. Cl. CPC H04W 4/02; G01P 21/00; G01P 15/18; G06N 5/022

(57) ABSTRACT

According to an example aspect of the present invention, there is provided an apparatus comprising at least one processing core, at least one memory including computer program code, the at least one memory and the computer program code being configured to, with the at least one processing core, cause the apparatus at least to determine a placement of the apparatus with respect to a user, determine a confidence level of the determination of the placement, and based at least in part on the placement and the confidence level, select either a classifier specific to the placement or a general classifier. Calibrated and/or uncalibrated sensor information may be used in phases of implementing the invention.

### FIELD OF INVENTION

The present invention relates to processing sensor information to increase the usability thereof.

### BACKGROUND OF INVENTION

Mobile devices enabled to be carried on the person of the user may benefit from awareness of their context. For example, when a mobile device with wireless communication capability moves at a fast speed, it may be configured to adapt its channel estimator to optimize performance of its radio transceiver or cellular network handover parameters such as time to trigger and hysteresis.

More generally, a device may adapt its functioning to specific circumstances where it finds itself, for example when outdoors a higher volume may be desirable than indoors, and in certain circumstances a device may adopt a silent profile so as to not cause disturbance.

Wearable gadgets, mobile phones, smartphones, tablet computers and other devices may be used by users in a plurality of different situations, and adapting to the situations may provide benefits in usability, in dependence of the actual use the user is using the device for, and the specific situation. A smartphone, for example, may be used in a number of ways, such as for example as a telephone, a gaming unit, a mapping unit, a text editing device, an alarm clock and an e-book reader.

Devices may comprise sensors, such as for example acceleration sensors and/or satellite positioning receivers, to gather sensor information. Examples of satellite positioning receivers include global positioning system, GPS, Galileo and GLONASS receivers. Some receivers are enabled to receive signals from more than one satellite positioning constellation. Where a device is used to measure a distance that the user walks or jogs, for instance, the device may benefit from knowing whether the user has attached it to his wrist, or whether the device is in a pocket.

Where sensors are present on a device, the sensors may be calibrated to produce more usable data. For example, moving a device in a shape of the number 8 may be helpful in calibrating a compass unit comprised in the device.

### SUMMARY OF THE INVENTION

According to a first aspect of the present invention, there is provided an apparatus comprising at least one processing core, at least one memory including computer program code, the at least one memory and the computer program code being configured to, with the at least one processing core, cause the apparatus at least to determine a placement of the apparatus with respect to a user, determine a confidence level of the determination of the placement, and based at least in part on the placement and the confidence level, select either a classifier specific to the placement or a general classifier.

Various embodiments of the first aspect may comprise at least one feature from the following bulleted list:
the at least one memory and the computer program code are configured to, with the at least one processing core, cause the apparatus to select the classifier specific to the placement responsive to the confidence level exceeding a threshold
the at least one memory and the computer program code are configured to, with the at least one processing core, cause the apparatus to select the general classifier responsive to the confidence level not exceeding the threshold
the placement comprises one of a wrist, a pocket, a backpack and a hand
the at least one memory and the computer program code are configured to, with the at least one processing core, cause the apparatus to determine the placement based on output of a sensor
the sensor comprises a sensor from the following list: an accelerometer, a satellite positioning sensor and a radio receiver
the at least one memory and the computer program code are configured to, with the at least one processing core, cause the apparatus to determine the confidence level based at least in part on a reference data set by comparing sensor information to the reference data set
the at least one memory and the computer program code are configured to, with the at least one processing core, cause the apparatus to determine a state of the apparatus based at least in part on the classifier specific to the placement
the state of the apparatus comprises one of the following: stationary, at rest, walking, running, riding a bicycle, being in a vehicle and unknown
the at least one memory and the computer program code are configured to, with the at least one processing core, cause the apparatus to determine the state based at least in part on a reference data set by comparing sensor information to the reference data set

According to a second aspect of the present invention, there is provided an apparatus comprising at least one processing core, at least one memory including computer program code, the at least one memory and the computer program code being configured to, with the at least one processing core, cause the apparatus at least to collect sensor information, determine a calibration model, and cause transmission of at least one of the sensor information, calibrated sensor information and the calibration model to a network.

Various embodiments of the second aspect may comprise at least one feature from the following bulleted list:
the at least one memory and the computer program code are configured to, with the at least one processing core, cause the apparatus to receive from the network at least one classifier
the at least one memory and the computer program code are configured to, with the at least one processing core, cause the apparatus to replace a previously stored classifier with the received classifier
the received classifier enables determination of a state of the apparatus
the state of the apparatus comprises one of the following: stationary, at rest, walking, running, riding a bicycle, being in a vehicle and unknown
determining the calibration model comprises determining an output of a sensor in a neutral state
the sensor comprises an acceleration sensor and the neutral state comprises a rest state
the apparatus is configured to collect the sensor information responsive to a determination that the apparatus is at rest
the at least one memory and the computer program code are configured to, with the at least one processing core, cause the apparatus to cause transmission of the sensor information at least in part before causing transmission of the calibration model

According to a third aspect of the present invention, there is provided a method comprising determining a placement of an apparatus with respect to a user, determining a confidence level of the determination of the placement, and selecting, based at least in part on the placement and the confidence level, either a classifier specific to the placement or a general classifier.

Various embodiments of the third aspect may comprise at least one feature from the preceding bulleted list laid out in connection with the first aspect.

According to a fourth aspect of the present invention, there is provided a method, comprising collecting sensor information, determining a calibration model, and causing transmission of at least one of the sensor information, calibrated sensor information and the calibration model to a network.

Various embodiments of the fourth aspect may comprise at least one feature from the preceding bulleted list laid out in connection with the second aspect.

According to a fifth aspect of the present invention, there is provided an apparatus comprising means for determining a placement of an apparatus with respect to a user, means for determining a confidence level of the determination of the placement, and means for selecting, based at least in part on the placement and the confidence level, either a classifier specific to the placement or a general classifier.

According to a sixth aspect of the present invention, there is provided an apparatus, comprising means for collecting sensor information, means for determining a calibration model, and means for causing transmission of at least one of the sensor information, calibrated sensor information and the calibration model to a network.

According to a seventh aspect of the present invention, there is provided a non-transitory computer readable medium having stored thereon a set of computer readable instructions that, when executed by at least one processor, cause an apparatus to at least determine a placement of an apparatus with respect to a user, determine a confidence level of the determination of the placement, and select, based at least in part on the placement and the confidence level, either a classifier specific to the placement or a general classifier.

According to an eighth aspect of the present invention, there is provided a non-transitory computer readable medium having stored thereon a set of computer readable instructions that, when executed by at least one processor, cause an apparatus to at least collect sensor information, determine a calibration model, and cause transmission of at least one of the sensor information, calibrated sensor information and the calibration model to a network.

According to a ninth aspect of the present invention, there is provided a non-transitory computer readable medium having stored thereon a set of computer readable instructions that, when executed by at least one processor, cause an apparatus to at least receive uncalibrated sensor information from a device, cause storage of the uncalibrated sensor information in a storage function, receive a calibration model from the device, and cause the stored uncalibrated sensor information, at least in part, to be calibrated to yield calibrated sensor information.

### Industrial Applicability

At least some embodiments of the present invention find industrial application in enabling more accurate adaptation of devices to their circumstances, and/or in identification of circumstances surrounding a device more reliably.

### BRIEF DESCRIPTION OF THE DRAWINGS

FIG. 1 illustrates an example system capable of supporting at least some embodiments of the present invention;

FIG. 2 illustrates an example use case in accordance with at least some embodiments of the present invention;

FIG. 3 illustrates an example apparatus capable of supporting at least some embodiments of the present invention;

FIG. 4 is a flow graph in accordance with at least some embodiments of the present invention;

FIG. 5 is a flow graph in accordance with at least some embodiments of the present invention;

FIG. 6 is a flow graph in accordance with at least some embodiments of the present invention;

FIG. 7 illustrates angles relating to an accelerometer;

FIG. 8 illustrates accelerometer self-calibration;

FIG. 9 illustrates a rest state acceleration detection algorithm;

FIG. 10 is a first flow graph of a first method in accordance with at least some embodiments of the present invention, and

FIG. 11 is a second flow graph of a second method in accordance with at least some embodiments of the present invention.

### DETAILED DESCRIPTION OF EXAMPLE EMBODIMENTS

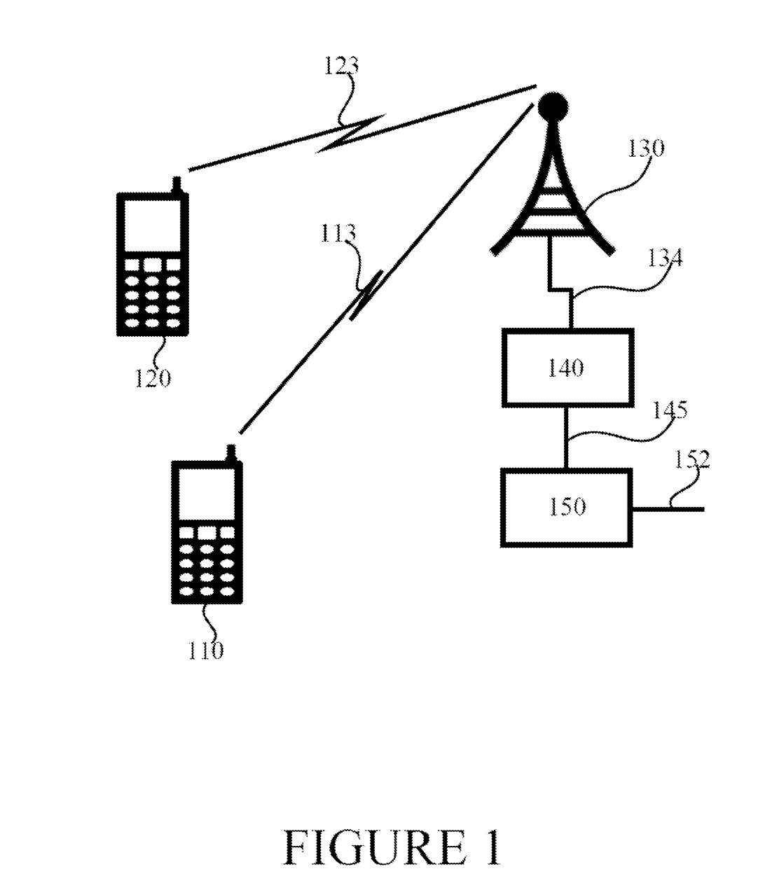

FIG. 1 illustrates an example system capable of supporting at least some embodiments of the present invention. Illustrated in FIG. 1 is device 110, which may comprise, for example, a mobile phone, a smartphone, tablet computer, laptop computer or other device with wired or wireless connectivity. Device 110 is illustrated as being in wireless connectivity with base station 130 via link 113. Although illustrated as a wireless link, in some embodiments link 113 is a wire-line link, such as for example a universal serial bus, USB, or Ethernet link. A wireless link may conform to a suitable cellular or non-cellular wireless communication technology. Examples of cellular wireless communication technologies include long term evolution, LTE, and wireless code division multiple access, WCDMA, technologies. Examples of non-cellular wireless communication technologies include wireless local area network, WLAN, also known as Wi-Fi, and worldwide interoperability for microwave access, WiMAX, technologies.

Device 120 may comprise another device with wired or wireless connectivity. It may be of a same type, or of a different type, as device 110. Like device 110, device 120 is illustrated as being in wireless connectivity with base station 130, via link 123. Like link 113, link 123 may be wireless or wire-line. While devices 110 and 120 are illustrated in FIG. 1 as mobile phones, the invention is not restricted thereto, rather the illustration is merely an example.

Base station 130 may comprise a base unit configured to support a communication protocol used by device 110 and/or device 120. For example, where link 113 is a WLAN link, base station 130 may be configured to act as a WLAN hub, or access point, and to participate in the link. Likewise, where link 123 is an Ethernet connection, base station 130 may comprise an Ethernet hub. A WLAN or LTE base station can participate in links that conform to those standards. In some embodiments, device 120 is connected via link 123 to a different base station than base station 130. For example, device 110 may be connected via link 113 to an in-home WLAN hub, and device 120 may be connected via link 123 to a cellular base station.

Base station 130 may be connected, via connection 134, to network node 140. For example, where base station 130 comprises a cellular base station, network node 140 may comprise a node in a cellular core network, such as for example a switch of mobility management entity. Network node 140 may be connected, via connection 145, to gateway 150. Gateway 150 may provide connectivity to further networks via connection 152. In some embodiments, network node 140 may be absent and base station 130 may be directly connected to gateway 150.

Device 110 may be configured to attempt to determine the circumstances where it is being used. To that end, device 110 may comprise a sensor, such as for example an accelerometer or a gyroscope or a magnetometer or a barometer or a satellite positioning receiver. An accelerometer may comprise, for example, a 3-axis microelectromechanical system, MEMS, accelerometer enabled to measure acceleration with respect to three independent axes simultaneously. A satellite positioning receiver may comprise a GPS, Galileo and/or GLONASS receiver module.

Device 110 may rely on at least one classifier to determine the circumstances where it is being used. For example, device 110 may be furnished with a classifier enabling it to attempt to deduce whether the user is walking, driving a car or immobile. Such a classifier may comprise a reference dataset to which information from a sensor comprised in device 110 can be compared, to determine a best match corresponding to an activity device 110 will then assume the user is engaged in. For example, if information from an accelerometer best matches reference data associated with jogging, device 110 may determine that the user is jogging and carrying device 110 with him. A classifier may thus comprise a set of reference data to which actual sensor information may be compared. Alternatively or additionally a classifier may comprise a set of classification rules, for example classification rules that allow to predict activity from sensor data, obtained from the reference data as the result of classifier training.

Alternatively to using a single classifier, device 110 may be configured with a plurality of classifiers. For example, device 110 may be configured to first determine a placement of device 110 with respect to a user. In other words, device 110 may determine how it is attached with respect to the user. For example, it may be attached to a wrist, carried in a pocket, carried in hand or in a backpack.

Device 110 may subsequently select a placement specific classifier based at least in part on the determined placement. For example where the sensor comprises an accelerometer, sensor information obtained from the sensor will be different for e.g. a jogging user depending on where on the body of the user device 110 is disposed. Therefore, by first determining a placement and then determining an activity the user is engaged in using a placement specific classifier, a reliability of the determined activity may be enhanced. In general sensor information may be seen as the output data of a sensor. Thus device 110 may have a wrist-specific classifier enabling the device to determine an activity when attached to a wrist, a pocket-specific classifier enabling the device to determine an activity when, and so on.

The placement may be determined, for example, by using a placement classifier. For example, by matching an amplitude and frequency pattern output by a sensor to reference data, the placement may be determined. Alternatively or additionally, output of sensor may be transformed to a set of features and compared with reference ones. In connection with determining the placement, device 110 may determine a confidence level of the determination of the placement. The confidence level may be determined based on how well sensor information matches with the best-matching reference data set in the placement classifier, for example. Responsive to the confidence level being above a threshold level, device 110 may take into use the placement-specific classifier corresponding to the determined placement. Responsive to the confidence level being below the threshold level, device 110 may take into use the generic classifier corresponding to no placement in particular.

Device 110 or device 120 may receive updates to classifiers via link 113 or link 123, respectively. Thus where, for example, new footwear come into fashion, it may change walk manner, classifiers may be updated to enable device determination that a user is walking in such a new footwear, which may not have been prevalent initially when the device was manufactured.

Characteristics of a person's gait may be used to identify the person, wherein such characteristics may appear different depending on how the user is carrying the device—on a wrist, in a pocket or in a backpack, for example.

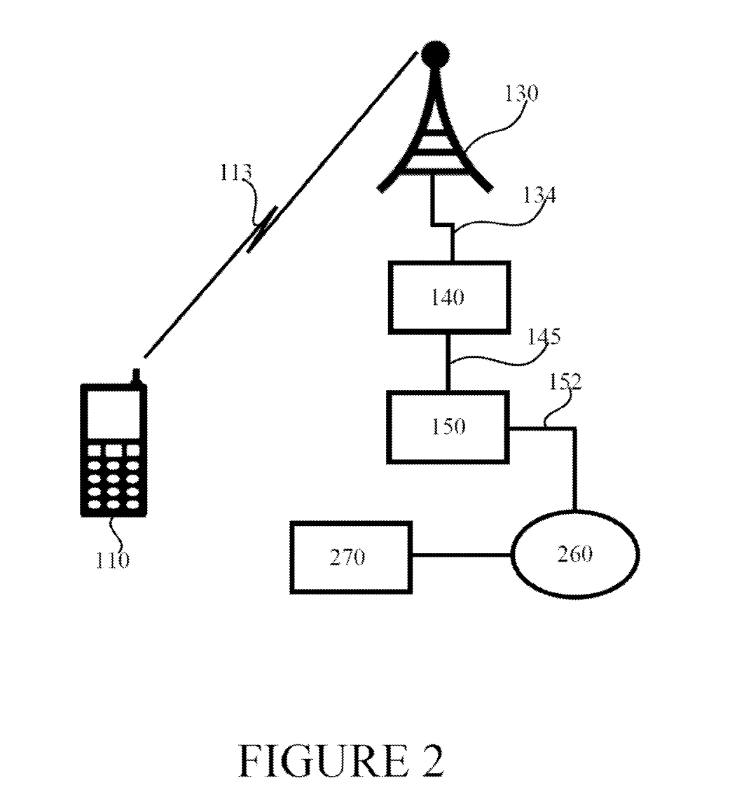

FIG. 2 illustrates an example use case in accordance with at least some embodiments of the present invention. Like reference numerals in FIG. 2 denote like structure as in FIG. 1. In addition to structure present in FIG. 1, FIG. 2 has network 260 and service 270. Service 270 is communicatively coupled with gateway 150 via network 260. In some embodiments, service 270 is disposed in network 260. Device 110 is enabled to communicate with service 270 via link 113, base station 130, connection 134, network node 140, link 145, gateway 150, connection 152 and network 260. Network 260 may comprise the Internet, for example.

Device 110 may obtain from a sensor comprised in device 110 calibrated and uncalibrated sensor information. Device 110 may provide calibrated sensor information to service 270, thereby enabling service 270 to use the calibrated sensor information in preparing new classifiers, or amending existing classifiers. Such new or amended classifiers may subsequently be provided to device 110 and/or similar devices, to thereby improve reliability of their operation. The calibrated sensor information device 110 provides to service 270 may comprise an indicator indicating the sensor information is calibrated.

Alternatively to calibrated sensor information, device 110 may provide to service 270 uncalibrated sensor information. The uncalibrated sensor information device 110 provides to service 270 may comprise an indicator indicating the sensor information is uncalibrated. Service 270 may store the uncalibrated sensor information. When device 110 calibrates its sensor, it thereby determines a calibration model. A calibration model describes biases of the sensor which enable calibrated sensor information to be obtained from the sensor. For example, in case the sensor comprises a 3-axis accelerometer, the calibration model may comprise for each of the axes a drift value which the accelerometer outputs as a measured acceleration value in the direction of the axis when no acceleration is really occurring. Therefore, by subtracting the contents of the calibration model from uncalibrated sensor information, the uncalibrated sensor information is converted into calibrated sensor information.

Device 110 may be configured to provide the calibration model to service 270. Being in receipt of the calibration model, service 270 is enabled to convert previously received uncalibrated sensor information of device 110 to calibrated sensor information of device 110. This calibrated sensor information may then be used in a way similar to sensor information received from device 110 in already calibrated form.

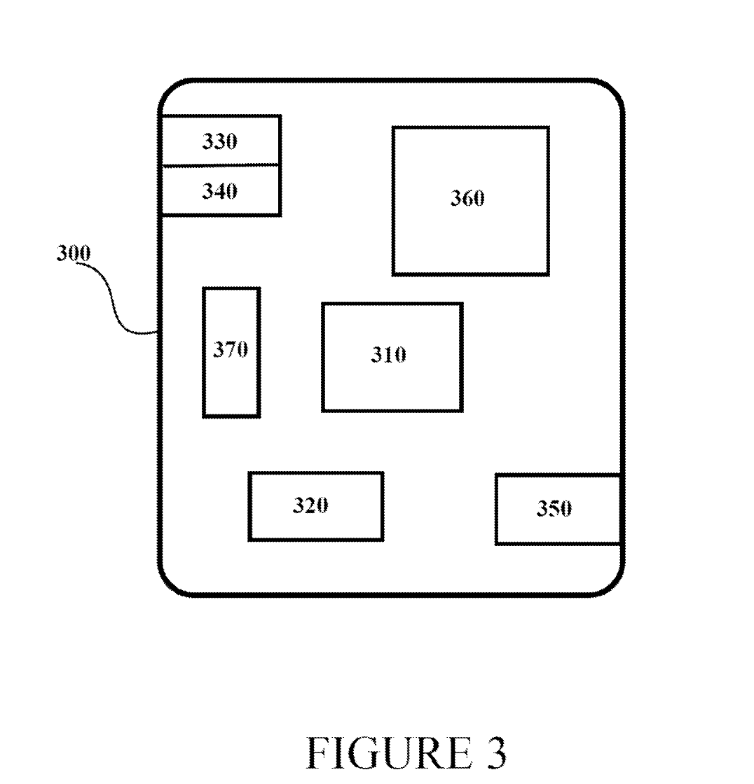

FIG. 3 illustrates an example apparatus capable of supporting at least some embodiments of the present invention. Illustrated is device 300, which may comprise, for example, a device such as device 110 of FIG. 1 or FIG. 2. Comprised in device 300 is processor 310, which may comprise, for example, a single- or multi-core processor wherein a single-core processor comprises one processing core and a multi-core processor comprises more than one processing core. Processor 310 may comprise a Qualcomm Snapdragon 800 processor, for example. Processor 310 may comprise more than one processor. A processing core may comprise, for example, a Cortex-A8 processing core manufactured by Intel Corporation or a Brisbane processing core produced by Advanced Micro Devices Corporation. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions. Processor 310 may comprise a digital signal processor, DSP, or microcontroller unit, MCU, component tailored for low-power processing of sensor data, for example a Qualcomm Sensor Core.

Device 300 may comprise memory 320. Memory 320 may comprise random-access memory and/or permanent memory. Memory 320 may comprise at least one RAM chip. Memory 320 may comprise magnetic, optical and/or holographic memory, for example. Memory 320 may be at least in part accessible to processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370. Device 300 may comprise a sensor, such as for example an accelerometer or a satellite positioning receiver.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

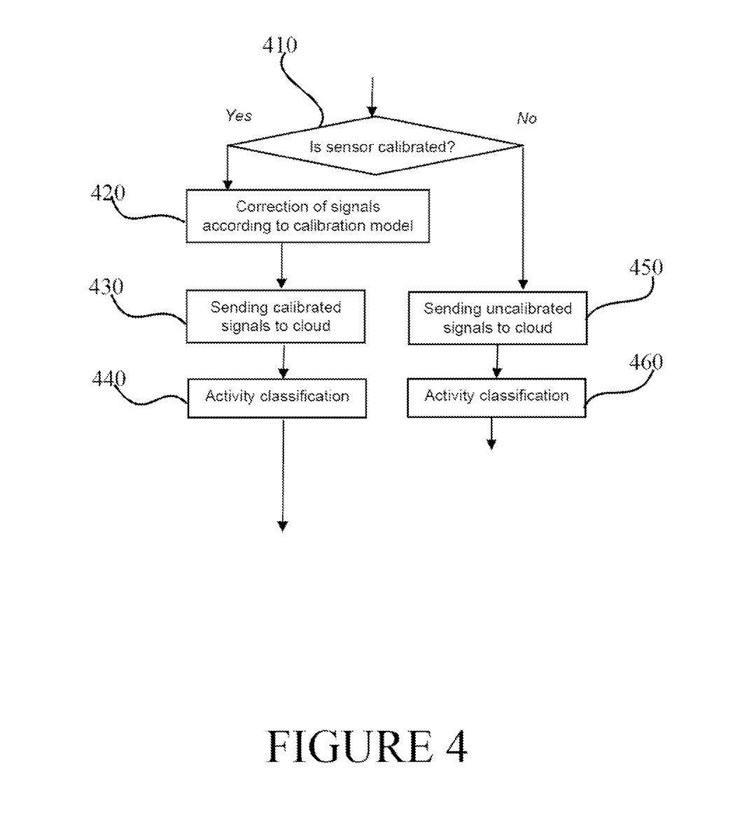

FIG. 4 is a flow graph in accordance with at least some embodiments of the present invention. The phases of the illustrated method may be performed in device 110, for example, or in a control device configured to control the functioning of device 110. Phase 410 receives uncalibrated sensor information, and in phase 410 it is determined whether the sensor is calibrated. In case the sensor is calibrated, processing advances to phase 420, where the calibration model is used to convert the uncalibrated sensor information into calibrated sensor information. Subsequently, in phase 430, the calibrated sensor information is sent to a cloud, or in general a network node. The sensor signals may be sent, at least in part, in compressed form. In phase 440, activity classification is performed based at least in part on the calibrated sensor information and at least one classifier.

If on the other hand in phase 410 it is determined the sensor is not calibrated, that is, no calibration model exists for the sensor, the uncalibrated sensor information is sent to the cloud, or in general a network node, in phase 450. Activity classification may follow, in phase 460, based on the uncalibrated sensor information.

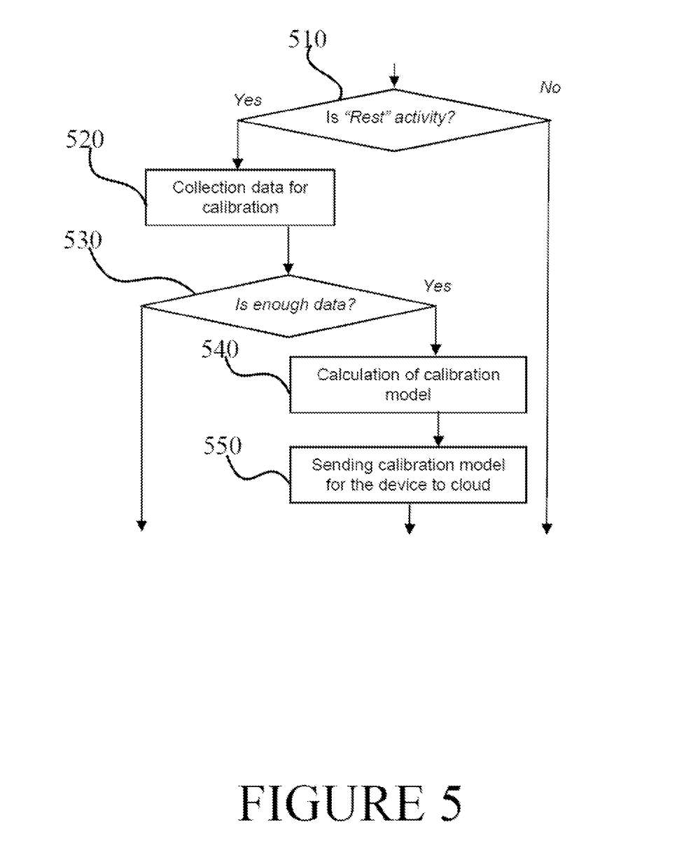

FIG. 5 is a flow graph in accordance with at least some embodiments of the present invention. Processing starts at phase 510, which may follow phase 460 of FIG. 4, for example, in case in phase 460 it is determined that the device, such as device 110, is at rest. If this is the case, processing advances to phase 520, where data is collected for calibration purposes. For example, sensor information representing five or 10 seconds of immobile reading from an accelerometer may be collected. While the information is collected, phase 530 is performed wherein it is determined, if enough data has been collected. In case a sufficient body of data has not yet been collected, in phase 530 uncalibrated data may, optionally, be sent to a cloud, or in general a network node. In case it is determined, however, in phase 530 that a sufficiently large body of information has been harvested from the sensor, a calibration model is derived from the harvested sensor information, phase 540. Subsequently, in phase 550, the calibration model may be provided to the cloud, or more generally the network node.

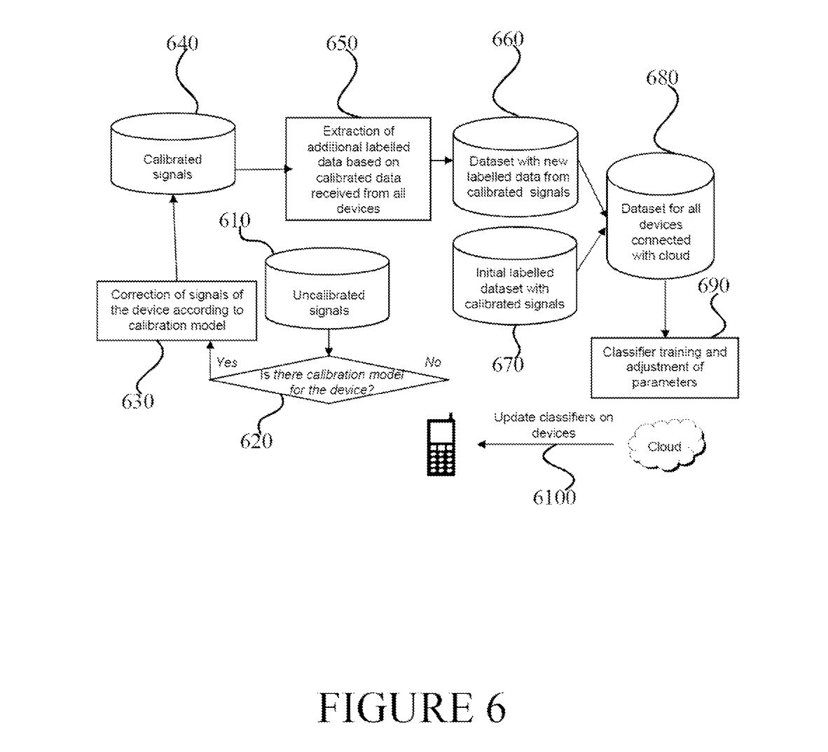

FIG. 6 is a flow graph in accordance with at least some embodiments of the present invention. FIG. 6 illustrates operations at service 270, corresponding to the cloud, or in general network node, of FIG. 4 and FIG. 5.

In storage 610, uncalibrated signals, comprising uncalibrated sensor information, received from a device, such as for example device 110 of FIG. 1, are stored. In phase 620, it is checked whether a calibration model is known for this particular device. If no, the process will wait for the calibration model. During the wait, further uncalibrated sensor information may be received and stored.

If on the other hand a calibration model is known for this particular device, processing advances to phase 630 wherein the uncalibrated sensor information is corrected with the calibration model to obtain calibrated sensor information, which is stored in storage 640.

In phase 650, calibrated sensor information from more than one device is used to extend an existing dataset stored in storage 660, which contains information to perform training of previously existing classifiers and/or adjustment of their parameters ( ) based on observing characteristics of the calibrated sensor information from more than one device. For example, where the calibrated sensor information exhibits a new kind of periodicity or statistical characteristic not yet captured in a classifier, a new classifier based on this statistical characteristic may be defined.

Storage 680 stores a new set of classifiers defined at least in part based on previously existing classifiers 670 and the dataset from storage 660. In phase 690, the set of classifiers may be tuned to improve its functionality.

In phase 6100, the updated classifiers are caused to be pushed to devices of suitable type.

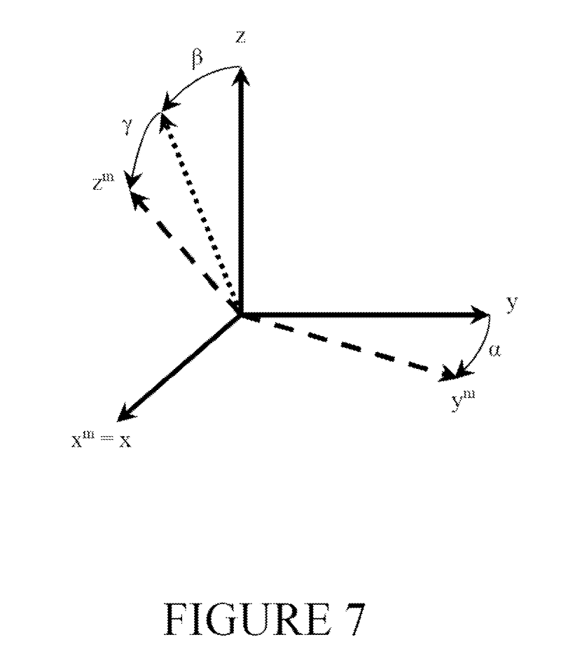

FIG. 7 illustrates angles relating to an example accelerometer. Signals from a 3-axes accelerometer are sampled with rate from 20 to 40 Hz. Activity recognition software is run to detect the “Rest” activity.

If “Rest” state is detected, then the device can perform self-calibration and estimation of noise levels (and optionally power spectral densities) for all accelerometer channels. MEMS accelerometer's output differs from the measured acceleration due to different factors like environmental conditions (temperature, humidity), fabrication imprecision, electrical influences. Different measurement models have been proposed to quantify this. The simplest linear two parametric model assumes that the three accelerometer axes produce the same voltage for the same acceleration. That is, output voltage vᵢ of each axis i is given by multiplication of the measured acceleration aᵢ by gain g and offset by bias b:

vᵢ=gaᵢ+b.

Here all three axes share the same gain and bias. The more realistic model allows individual gains gᵢ and biases bᵢ per each axis:

vᵢ=gᵢaᵢ+bᵢ

Such six parameters measurement model results in more accurate accelerometer calibration. MEMS accelerometer axes are not perfectly orthogonal to each other, and also there is cross-talk between individual axis channels. The above two and six parameter models are unable to model such effects, more involved nine parameters model described further is needed.

We consider the following measurement model that relates triaxial accelerometer's output signal v to true acceleration a: each axis has multiplicative gain and additive bias, moreover we take into account axis misaligned caused by non-orthogonality, see FIG. 7.

Let's consider two sets of basis vectors: x, y, z corresponding to orthonormal coordinate system, and x^{m}, y^{m}, z^{m} corresponding to misaligned (non-orthogonal) coordinate system. The orthonormal basis vectors are chosen such that x^{m}+x. The misaligned basis vector y^{m} is obtained by rotating around z by an angle α:

$${y}^{m} = ( \begin{matrix} cos ( α ) & - sin ( α ) & 0 \\ sin ( α ) & cos ( α ) & 0 \\ 0 & 0 & 1\end{matrix} ) ( \begin{matrix}0 \\ 1 \\ 0\end{matrix} ) = ( \begin{matrix}- sin ( α ) \\ cos ( α ) \\ 0\end{matrix} )$$

The misaligned basis vector z^{m} is obtained by (i) rotating around y by an angle β, (ii) rotating around x by an angle γ:

$$\begin{matrix}{z}^{m} = ( \begin{matrix}1 & 0 & 0 \\ 0 & cos ( γ ) & - sin ( γ ) \\ 0 & sin ( γ ) & cos ( y )\end{matrix} ) ( \begin{matrix}cos ( β ) & 0 & - sin ( β ) \\ 0 & 1 & 0 \\ sin ( β ) & 0 & cos ( β )\end{matrix} ) ( \begin{matrix}0 \\ 0 \\ 1\end{matrix} ) \\ = ( \begin{matrix}- sin ( β ) \\ - sin ( γ ) cos ( β ) \\ cos ( γ ) cos ( β )\end{matrix} )\end{matrix}$$

Transformation of coordinates from orthogonal x, y, z to misaligned system x^{m}, y^{m}, z^{m} is performed according to

$${a}^{m} = La = ( \begin{matrix}1 & 0 & 0 \\ - sin ( α ) & cos ( α ) & 0 \\ - sin ( β ) & - sin ( γ ) cos ( β ) & cos ( γ ) cos ( β )\end{matrix} ) a ,$$

where a is acceleration vector in orthogonal coordinates, a^{m}—in misaligned. The accelerometer's output v is given by

$$v = {Ga}^{m} + b = GLa + b = ( \begin{matrix}{g}_{1} & 0 & 0 \\ 0 & {g}_{2} & 0 \\ 0 & 0 & {g}_{3}\end{matrix} ) La + ( \begin{matrix}{b}_{1} \\ {b}_{2} \\ {b}_{3}\end{matrix} )$$

where B is gain matrix, b is bias. The inverse transformation from measurements v to acceleration a is given by

$$\begin{matrix}a = {( GL )}^{1} ( v - b ) \\ = ( \begin{matrix}\frac{1}{{g}_{1}} & 0 & 0 \\ \frac{s ( α )}{{g}_{1} c ( α )} & \frac{1}{{g}_{2} c ( α )} & 0 \\ \frac{c ( α ) s ( β ) + c ( β ) s ( α ) s ( γ )}{{g}_{1} c ( α ) c ( β ) c ( γ )} & \frac{s ( γ )}{{g}_{2} c ( α ) c ( γ )} & \frac{1}{{g}_{3} c ( β ) c ( γ )}\end{matrix} ) \\ ( v - b ) \\ \approx ( \begin{matrix}\frac{1}{{g}_{1}} & 0 & 0 \\ \frac{α}{{g}_{1}} & \frac{1}{{g}_{2}} & 0 \\ \frac{β + α γ}{{g}_{1}} & \frac{s ( γ )}{{g}_{2}} & \frac{1}{{g}_{3}}\end{matrix} ) ( v - b ) \\ = K ( v - b ) \\ = ( \begin{matrix}{k}_{1} & 0 & 0 \\ {k}_{4} & {k}_{2} & 0 \\ {k}_{5} & {k}_{6} & {k}_{3}\end{matrix} ) ( v - b )\end{matrix}$$

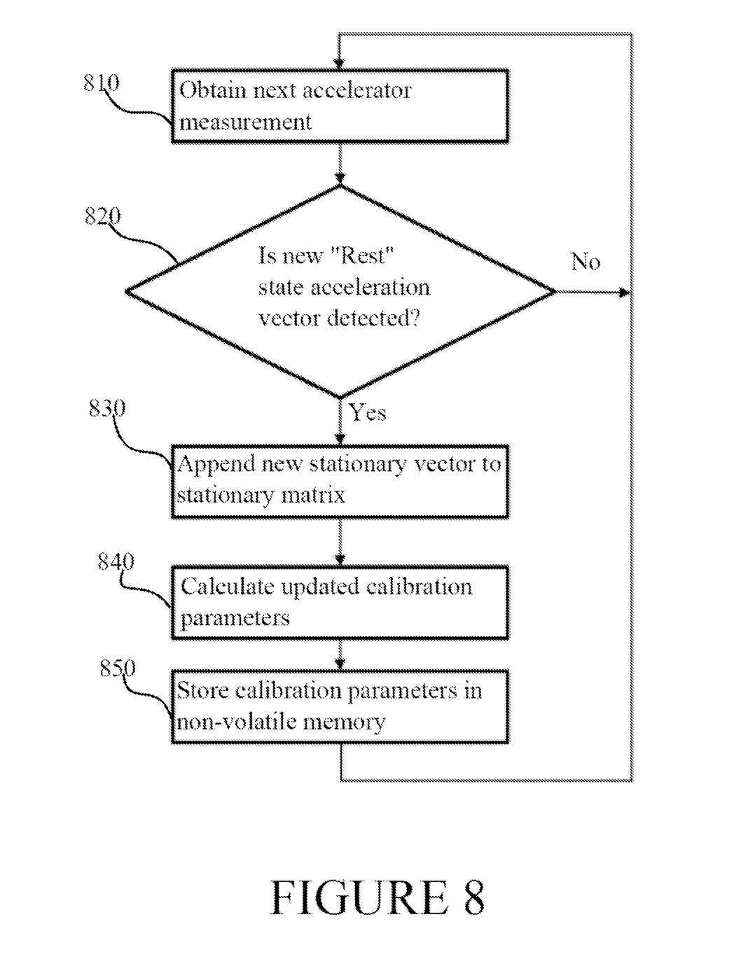

FIG. 8 illustrates accelerometer self-calibration. “Rest” state detection is performed in phase 820 after receiving new accelerometer measurement in phase 810. The average acceleration vector is appended to the stored rest acceleration matrix once the new rest device orientation is detected, phase 830. Calibration parameters are calculated in phase 840, and are stored in phase 850.

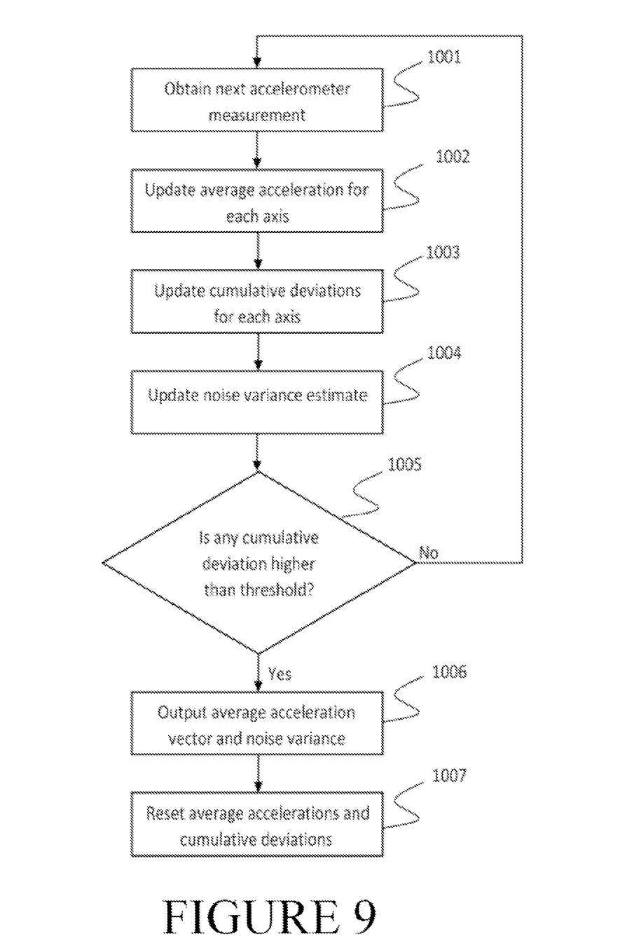

FIG. 9 illustrates a rest state detection algorithm. Rest detection algorithm may run continuously, and receive raw accelerometer measurements and outputs average acceleration vector after new rest device position was detected. In phase 1002 of this algorithm exponential averaged acceleration w̅ is updated for each of the three axes based on raw accelerometer signal w as

w̅ₜ₊₁=0.99w̅ₜ+0.01wₜ.

Upper d^{U} and d^{L} lower cumulative deviations are updated in phase 1003 as

dₜ₊₁^{U}=max(0,dₜ₊₁^{U}+wₜ−w̅ₜ₊₁−0.01)dₜ₊₁^{L}=max(0,dₜ₊₁^{L}−wₜ+w̅ₜ₊₁−0.01)

New rest device orientation is detected in phase 1005 if any of the cumulative deviations get higher than threshold.

Length of acceleration vector l=∥a∥₂ given the measurement model is equal to:

$$\begin{matrix}l = {‖ a ‖}_{2} \\ = {α}^{T} a \\ = {( K ( v - b ) )}^{T} K ( v - b ) \\ = {v}^{T} {K}^{T} Kv - 2 {v}^{T} {K}^{T} Kb + {b}^{T} {K}^{T} Kb \\ = ( {k}_{1}^{2} + {k}_{4}^{2} + {k}_{5}^{2} ) {v}_{1}^{2} + ( {k}_{2}^{2} + {k}_{6}^{2} ) {v}_{2}^{2} + {k}_{3}^{2} {v}_{3}^{2} + \\ 2 ( {k}_{2} {k}_{4} + {k}_{5} {k}_{6} ) {v}_{1} {v}_{3} + 2 {k}_{3} {k}_{5} {v}_{1} {v}_{3} + 2 {k}_{3} {k}_{6} {v}_{2} {v}_{3} - \\ 2 ( {b}_{1} {k}_{1}^{2} + {b}_{1} {k}_{4}^{2} + {b}_{1} {k}_{5}^{2} + {b}_{2} {k}_{2} {k}_{4} + {b}_{2} {k}_{5} {k}_{6} + {b}_{3} {k}_{3} {k}_{5} ) {v}_{1} - \\ 2 ( {b}_{1} {k}_{2} {k}_{4} + {b}_{1} {k}_{5} {k}_{6} + {b}_{2} {k}_{2}^{2} + {b}_{2} {k}_{6}^{2} + {b}_{3} {k}_{3} {k}_{6} ) {v}_{2} - \\ 2 ( {b}_{1} {k}_{3}^{2} + {b}_{2} {k}_{3} {k}_{6} + {b}_{3} {k}_{3}^{2} ) {v}_{3} + {b}_{1}^{2} {k}_{1}^{2} + {b}_{1}^{2} {k}_{4}^{2} + {b}_{1}^{2} {k}_{5}^{2} + {b}_{2}^{2} {k}_{2}^{2} + \\ {b}_{2}^{2} {k}_{6}^{2} + {b}_{3}^{2} {k}_{3}^{2} + 2 {b}_{1} {b}_{2} {k}_{2} {k}_{4} + 2 {b}_{1} {b}_{2} {k}_{5} {k}_{6} + 2 {b}_{1} {b}_{3} {k}_{3} {k}_{5} + 2 {b}_{2} {b}_{3} {k}_{3} {k}_{6} \\ = {c}_{1} {v}_{1}^{2} + {c}_{2} {v}_{2}^{2} + {c}_{3} {v}_{3}^{2} + {c}_{4} {v}_{1} {v}_{2} + {c}_{5} {v}_{1} {v}_{3} + {c}_{6} {v}_{2} {v}_{3} + {c}_{7} {v}_{1} + \\ {c}_{8} {v}_{2} + {v}_{9} {v}_{3} + {c}_{10}\end{matrix}$$

Measurement model's calibration parameters K and b can calculated given c as

$${k}_{3} = \sqrt{{c}_{3}} , \\ {k}_{5} = \frac{{c}_{5}}{2 {k}_{3}} , \\ {k}_{6} = \frac{{c}_{6}}{2 {k}_{3}} , \\ {k}_{2} = \sqrt{{c}_{2} - {k}_{6}^{2}} , \\ {k}_{4} = \frac{{c}_{4} - 2 {k}_{5} {k}_{6}}{2 {k}_{2}} , \\ {k}_{4} = \frac{{c}_{4} - 2 {k}_{5} {k}_{6}}{2 {k}_{2}} , \\ D = - 2 ( \begin{matrix}{k}_{1}^{2} + {k}_{4}^{2} + {k}_{5}^{2} & {k}_{2} {k}_{4} + {k}_{5} {k}_{6} & {k}_{3} {k}_{5} \\ {k}_{2} {k}_{4} + {k}_{5} {k}_{6} & {k}_{2}^{2} + {k}_{5}^{2} & {k}_{3} {k}_{6} \\ {k}_{3} {k}_{5} & {k}_{3} {k}_{6} & {k}_{3}^{2}\end{matrix} ) , \\ b = {D}^{- 1} ( \begin{matrix}{c}_{7} \\ {c}_{8} \\ {c}_{9}\end{matrix} )$$

Most accelerometer calibration approaches are based on simple idea that ideal rest accelerometer's output vector length should equal to 1 g (gravity acceleration). Typical least squares approach is minimization of residual (squared deviations of lengths of measured accelerometer vectors from g) as function of calibration parameters. Calibration quality drops significantly with small number of measured rest acceleration vectors. To overcome this drawback calibration approach based on Tikhonov's regularization is proposed. The loss is composed of two parts: (i) residual as in least squares approach, (ii) regularization term that stabilizes calibration parameter estimates. That is calibration algorithm minimizes the following loss function:

$${min}_{c} {‖ l ( v , c ) - 1 ‖}_{2} + λ {‖ c ‖}_{2} ,$$

where λ is regularization parameter.

Detected rest acceleration vectors are stored as rows in rest acceleration matrix V. The first step of calibration parameters calculation algorithm (FIG. 3) is forming of covariates matrix U from V such that

Uₙ=(V_{n,1}² V_{n,2}² V_{n,3}² V_{n,1}V_{n,2} V_{n,1}V_{n,3} V_{n,2}V_{n,3} V_{n,1} V_{n,2} V_{n,3}).
Then the solution to the regularized least squares problem

$${min}_{c} {‖ Uc - 1 ‖}_{2} + λ {‖ c ‖}_{2}$$

is obtained as

c=(U^{T}U+λl)⁻¹U^{T}

After that calibration parameters K and b are calculated from the regression parameter c.

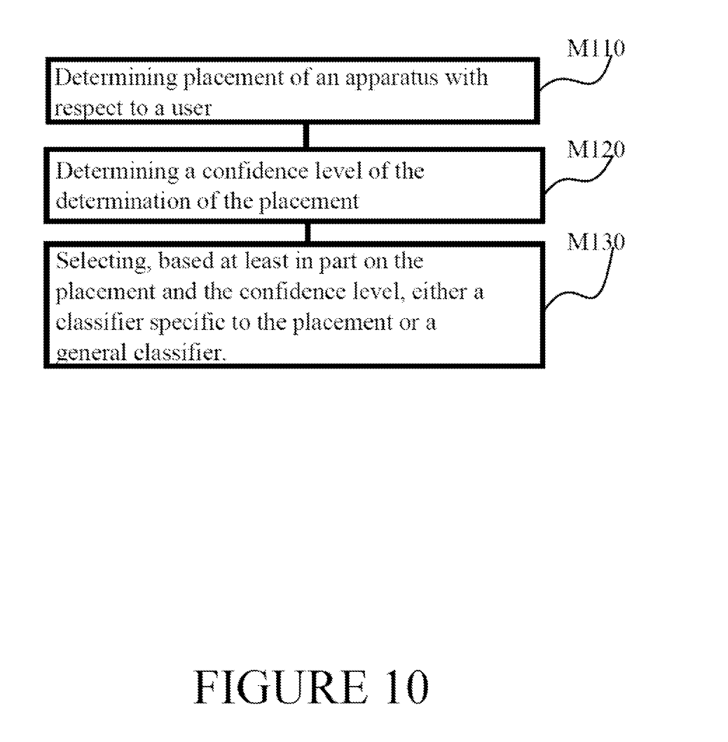

FIG. 10 is a first flow graph of a first method in accordance with at least some embodiments of the present invention. The phases of the illustrated method may be performed in device 110, for example, or in a control device configured to control the functioning of device 110, when implanted therein.

Phase M110 comprises determining a placement of an apparatus with respect to a user. Phase M120 comprises determining a confidence level of the determination of the placement. Finally, phase M130 comprises selecting, based at least in part on the placement and the confidence level, either a classifier specific to the placement or a general classifier.

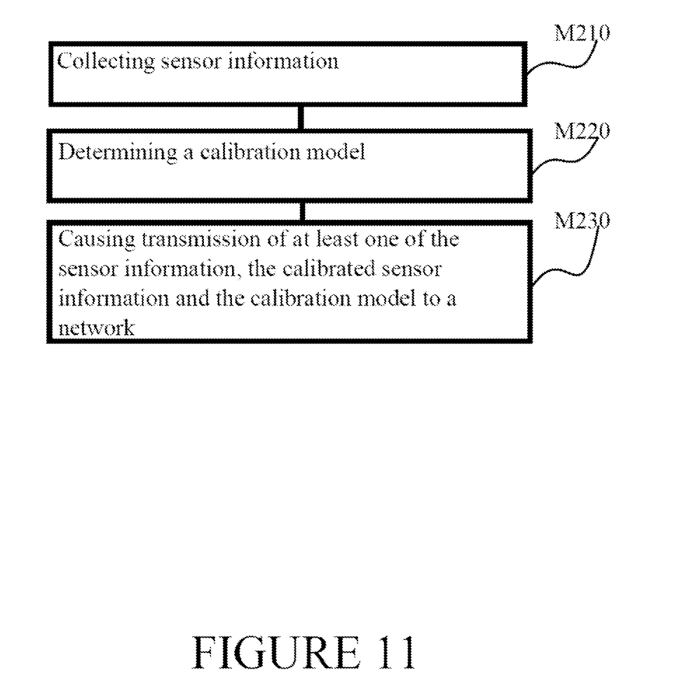

FIG. 11 is a second flow graph of a second method in accordance with at least some embodiments of the present invention. The phases of the illustrated method may be performed in device 110, for example, or in a control device configured to control the functioning of device 110, when implanted therein.

Phase M210 comprises collecting sensor information. Phase M220 comprises determining a calibration model. Finally, phase M230 comprises causing transmission of at least one of the sensor information, calibrated sensor information and the calibration model to a network.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1-44. (canceled)

45. An apparatus comprising at least one processing core, at least one memory including computer program code, the at least one memory and the computer program code being configured to, with the at least one processing core, cause the apparatus at least to:
determine a placement of the apparatus with respect to a user;
determine a confidence level of the determination of the placement, and
based at least in part on the placement and the confidence level, select either a classifier specific to the placement or a general classifier.

46. The apparatus according to claim 45, wherein the at least one memory and the computer program code are configured to, with the at least one processing core, cause the apparatus to select the classifier specific to the placement responsive to the confidence level exceeding a threshold.

47. The apparatus according to claim 45, wherein the at least one memory and the computer program code are configured to, with the at least one processing core, cause the apparatus to select the general classifier responsive to the confidence level not exceeding the threshold.

48. The apparatus according to claim 45, wherein the placement comprises one of a wrist, a pocket, a backpack and a hand.

49. The apparatus according to claim 45, wherein the at least one memory and the computer program code are configured to, with the at least one processing core, cause the apparatus to determine the placement based on output of a sensor.

50. The apparatus according to claim 49, wherein the sensor comprises a sensor from the following list: an accelerometer, a satellite positioning sensor, a radio receiver, a gyroscope, a magnetometer and a barometer.

51. The apparatus according to claim 45, wherein the at least one memory and the computer program code are configured to, with the at least one processing core, cause the apparatus to determine the confidence level based at least in part on a reference data set by comparing sensor information to the reference data set.

52. The apparatus according to claim 45, wherein the at least one memory and the computer program code are configured to, with the at least one processing core, cause the apparatus to determine a state of the apparatus based at least in part on the classifier specific to the placement.

53. The apparatus according to claim 52, wherein the state of the apparatus comprises one of the following: stationary, at rest, walking, running, riding a bicycle, being in a vehicle and unknown.

54. The apparatus according to claim 52, wherein the at least one memory and the computer program code are configured to, with the at least one processing core, cause the apparatus to determine the state based at least in part on a reference data set by comparing sensor information to the reference data set.

55. A method comprising:
determining a placement of an apparatus with respect to a user;
determining a confidence level of the determination of the placement, and
selecting, based at least in part on the placement and the confidence level, either a classifier specific to the placement or a general classifier.

56. The method according to claim 55, further comprising causing the apparatus to select the classifier specific to the placement responsive to the confidence level exceeding a threshold.

57. The method according to claim 55, further comprising causing the apparatus to select the general classifier responsive to the confidence level not exceeding the threshold.

58. The method according to claim 55, wherein the placement comprises one of a wrist, a pocket, a backpack and a hand.

59. The method according to claim 55, wherein the placement is determined based on output of a sensor.

60. The method according to claim 59, wherein the sensor comprises a sensor from the following list: an accelerometer, a satellite positioning sensor, a radio receiver, a gyroscope, a magnetometer and a barometer.

61. The method according to claim 55, wherein the confidence level is determined based at least in part on a reference data set by comparing sensor information to the reference data set.

62. The method according to claim 55, further comprising determining a state of the apparatus based at least in part on the classifier specific to the placement.

63. The method according to claim 62, wherein determining the state is based at least in part on a reference data set and comparing sensor information to the reference data set.

64. A non-transitory computer readable medium having stored thereon a set of computer readable instructions that, when executed by at least one processor, cause an apparatus to at least:
determine a placement of an apparatus with respect to a user;
determine a confidence level of the determination of the placement, and
select, based at least in part on the placement and the confidence level, either a classifier specific to the placement or a general classifier.
